(19) United States
(12) Patent Application Publication
(10) Pub. No.: US 2020/0182395 A1
(43) Pub. Date: Jun. 11, 2020

(54) SPLICING SCREEN SUPPORT STRUCTURE

(71) Applicant: Xiamen YinQiao Optoelectronics Technology Co.,Ltd., Fujian (CN)

(72) Inventors: Huihan RAO, Fujian (CN); Qixiang LI, Fujian (CN)

(73) Assignee: Xiamen YinQiao Optoelectronics Technology Co.,Ltd., Fujian (CN)

(21) Appl. No.: 16/663,329

(22) Filed: Oct. 24, 2019

(30) Foreign Application Priority Data
Dec. 10, 2018 (CN) 201811503315.2

(51) Int. Cl. F16M 11/04; F16M 11/42

(52) U.S. Cl. CPC F16M 11/04; G09F 9/3023; F16M 11/42

(57) ABSTRACT

A splicing screen support structure includes a base, a bracket, a plurality of hangers, a plurality of hooks, a plurality of first screws and a plurality of second screws; the splicing screen is attached to the bracket through the hanger, and the upper and lower positions of the splicing screen and the tilt of the splicing screen in the left and right direction are adjusted by the first screw, and the front and rear positions and the tilt of the splicing screen in the front and rear direction are adjusted by the second screw.

### CROSS-REFERENCE TO RELATED APPLICATION

This application claims the priority benefit of China application serial no. 201811503315.2, filed on Dec. 10, 2018. The entirety of the above-mentioned patent application is hereby incorporated by reference herein and made a part of this specification.

### TECHNICAL FIELD

The present application relates to the field of display screen technologies, and in particular, relates to a splicing screen support structure.

### BACKGROUND

The existing LED installation method usually requires a professional to install each single LED screen in a readymade cabinet in sequence to form a large-area screen, which has a complicated and long installation process, and a high labor cost. Therefore LED display screens preset as modular display products have been appeared, and the modular products can be assembled and spliced to reduce the installation cost of LED screens. However, in the splicing process of the multiple modular products, the spliced LED screen may be skewed or the corners may not be aligned due to the slight difference in the size of the preset modular products, which greatly reduces the visual perception.

### SUMMARY

The following is a summary of the subject matter described in detail herein, and is not intended to limit the scope of the claims.

The embodiment of the present application provides a splicing screen support structure for supporting a splicing screen formed by splicing a plurality of screen modules, including a base, a bracket, a plurality of hangers, a plurality of hooks, a plurality of first screws and a plurality of second screws; the bracket is fixed to the base and includes a horizontally extending crossbar; at least two hangers are respectively fixed to two sides of a back of each of the plurality of the screen modules in a one-to-one correspondence; each of the plurality of hooks is hooked to the crossbar and in a non-rotation connection with each of the plurality of hangers in a one-to-one correspondence; each of the plurality of first screws is screwed to each of the plurality of hooks in a vertical direction in a one-to-one correspondence and abuts against the crossbar; each of the plurality of second screws is rotatably connected to each of the plurality of hangers in a one-to-one correspondence while perpendicular to the crossbar in the horizontal direction, and each of the plurality of second screws is also screwed to each of the plurality of hooks in a one-to-one correspondence.

### BRIEF DESCRIPTION OF THE DRAWINGS

In order to more clearly illustrate the technical solutions of the embodiments of the present application, the following drawings, which are to be used in the description of the embodiments, are briefly introduced:

FIG. 1 is a structural schematic diagram according to the present embodiment.

FIG. 2 is a first structural schematic diagram of a hanger according to the present embodiment.

FIG. 3 is a second structural schematic diagram of the hanger according to the present embodiment.

FIG. 4 is a structural schematic diagram showing a connection structure of a bracket and a straight rod according to the present embodiment.

### DETAILED DESCRIPTION

The technical solutions in the embodiments of the present application will be clearly and completely described through embodiments and with reference to the accompanying drawings.

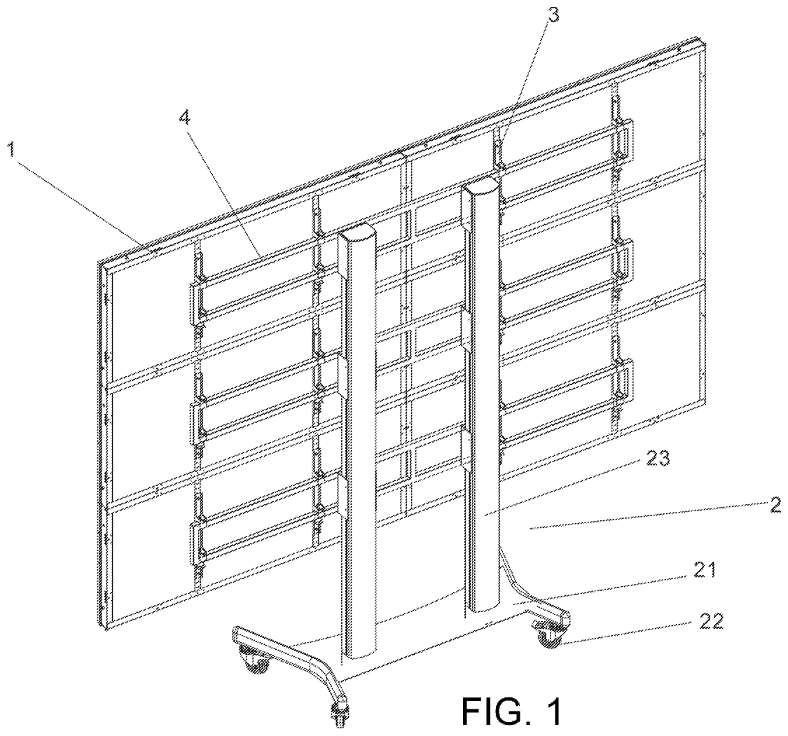

FIG. 1 shows a structural diagram of an embodiment of a splicing screen support structure provided by the present application, the splicing screen support structure is used for supporting a splicing screen spliced by a plurality of screen modules 1, and the splicing screen support structure includes a base 2, a plurality of hangers 3, a plurality of hooks 312, a plurality of brackets 4, a plurality of first screws 5, a plurality of second screws 6, a plurality of fourth screws 71, a plurality of clamping members 32, a plurality of sliders 33, and a plurality of third screws 34.

As shown in FIG. 1, each screen module 1 includes a frame and a plurality of LED display panels, and the plurality of LED display panels are fixed to the preset frame by magnetic attraction. Each screen module 1 has a uniform shape, and the plurality of screen modules can be spliced and combined into a large-area splicing screen.

The base 2 includes a base body 21 and a straight rod 23, and the base body 21 is a flat plate, and four universal wheels 22 are respectively mounted on the four corners of the bottom of the base body 21. The splicing screen support structure can be pushed to move around via the four universal wheels 22. The straight rod 23 is vertically fixed to the upper surface of the base body 21 by welding or screwing. In the present embodiment, two straight rods 23 are provided for supporting the splicing screen more stably.

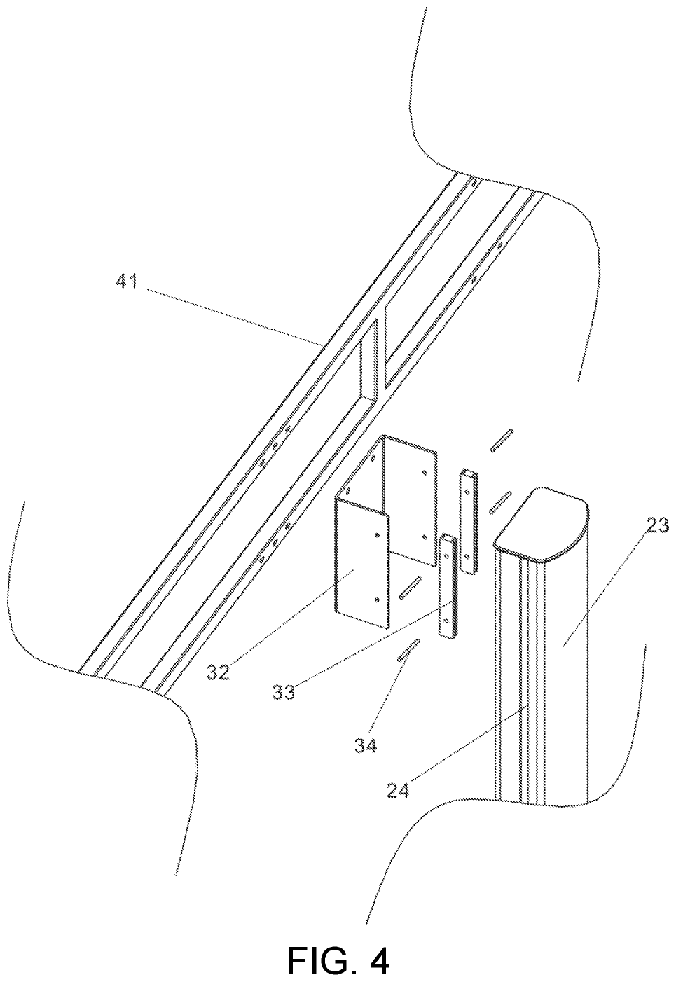

As shown in FIG. 4, two sliding slots 24 are respectively disposed on each side of the straight rod 23, the longitudinal direction of the sliding slot 24 is the same as the longitudinal direction of the straight rod 23, each of the free ends of the side walls of the sliding slot 24 extends inwardly to form a flange.

The structure of the bracket 4 is a frame structure, and the horizontally extending portion of the frame structure is the crossbar 41, the vertically extending portion of the frame structure is the vertical rod, and the upper crossbar 41 and the lower crossbar 41 are connected by the vertical rods.

The clamping member 32 and the slider 33 are cooperated to form a sliding connecting member, the clamping member 32 includes a first bottom plate and two first side plates, the two sides of the first bottom plate are respectively fixed to the two first side plates by welding, or the clamping member 32 is integrally formed. The first bottom plate is fixedly connected to the crossbar 41 of the bracket 4 by screwing, and each of the two first side plates is provided with a screw hole. The slider 33 is provided with a threaded through hole corresponding to the screw hole of the first side plate of the clamping member 32, the third screw 34 penetrates the screw hole of the first side plate of the clamping member 32 and the threaded through hole of the slider 33 to integrally connect the clamping member 32 and the slider 33. The width of the slider 33 matches the distance between the side walls of the sliding slot 24, at the same time, two grooves are respectively arranged on two sides of the slider 33, and the distance between the bottoms of the two grooves is smaller than the distance between the opposite faces of the two flanges on the sliding slot 24.

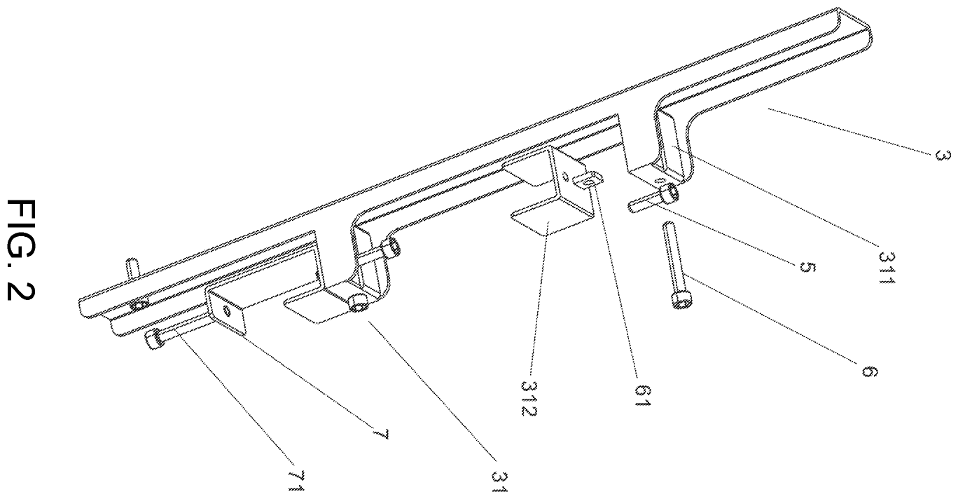

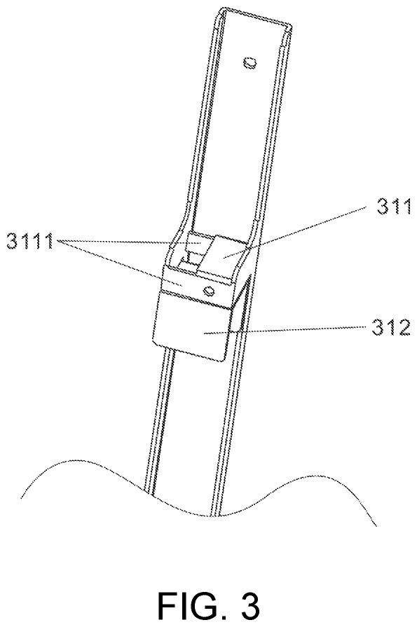

As shown in FIG. 2 and FIG. 3, the hanger 3 is in a long strip shape, and one side face of the hanger 3 is fixed to the frame on the back of the screen module 1 by screwing in the vertical direction. In the present embodiment, the position of the hanger 3 is set as shown in FIG. 1, and the hanger 3 is fixed on two sides of the back of each screen module 1 for adjusting the degree of skew in the left and right direction of the screen module 1.

A support portion is disposed on a side of the hanger 3 away from the screen module 1, and the support portion includes two second side plates extending from the two sides of the hanger 3 to a direction away the screen module 1, the free-ends of the two second side plates then extend toward each other to obtain a first support plate, and the initiating ends of the two second side plates also extend toward each other to obtain a second support plate opposite to the first support plate, the first and second support plates are respectively provided with a through hole 3111, the positions of the two through holes 3111 are corresponding with each other, the second screw 6 penetrates the through holes of the first and second support plates, and blocks for limiting the axial displacement of the second screw 6 are arranged at the two ends of the second screw 6, thereby achieving a rotational connection between the second screw 6 and the hanger 3, while the second screw 6 is perpendicular to the crossbar 41 in the horizontal direction. In addition, a horizontal convex plate 311 is further disposed between the first and second support plates, and the two sides of the horizontal convex plate 311 are respectively connected to the first and second support plate.

In this embodiment, each hanger 3 is provided with two support portions respectively disposed on the upper and lower sides of the hanger 3 for adjusting the degree of inclination of the screen module 1 in the front and rear direction of the screen module 1.

The hook 312 has an integrally formed structure, and includes a second bottom plate and two third side plates, the two third side plates are opposite to each other, a concave structure is formed between the second bottom plate and the two third side plates, and the concave structure can cooperate with the crossbar 42. A threaded through hole is arranged at the second bottom plate of the hook 312, and the first screw 5 penetrates the threaded through hole to form a threaded engagement with the hook 312. A nut 61 is fixed on the outer surface of the second bottom plate facing the convex plate 311, the nut 61 is axially parallel to the horizontal direction, and is screwed to the second screw 6 to connect the hook 312 to the hanger 3, and the upper end surface of the nut 61 abuts the bottom surface of the convex plate 311 to realize the non-rotation connection of the nut 61 and the hanger 3.

In the present embodiment, each hanger 3 is provided with two hooks 312 respectively corresponding to the positions of the support portions on the hanger 3.

In the present embodiment, the hook 312 on the lower side of the hanger 3 is preferably provided with a fixing plate 7. One third side plate of the hook 312 extends downward to a certain position, and then extends in a horizontal direction to obtain the fixing plate 7 opposite to the bottom plate of the hook 312. A threaded through hole is formed in the fixing plate 7, and the fourth screw 71 penetrates the threaded through hole and forms a threaded connection with the fixing plate 7.

When assembling, the hook 312 is first placed under the support portion with the screw hole of the nut 61 on the hook 312 being aligned with the through holes of the first and second support plates, and then the second screw 6 is sequentially inserted through the first support plate, the nut 61 and the second support plate, thereby connecting the hook 312 to the hanger 3. After each hanger 3 is mounted with the hooks 312, the two hangers 3 are screwed to the two sides of the frame on the back of the screen module 1. When the base 2 is assembled, the four universal wheels 22 are respectively fixed to the four corners of the base body 21, and the straight rod 23 and the base body 21 are welded or screwed to form a fixed connection. When the bracket 4 is assembled, the clamping member 32 is first screwed to the crossbar 41 of the bracket 4, and the two sliders 33 are fixed to the clamping member 32 by the third screws 34, and then the two sliders 33 are further respectively slid into the two sliding slots 24 on both sides of the straight rod 23. The third screws 34 abut against the bottom of the sliding slot 24, which drives the slider 33 to reversely abut against the flange of the sliding slot 24, thereby fixing the bracket 4.

During use, when the hook 312 is hooked on the crossbar 41, the height of the hanger 3 can be adjusted by adjusting the length of the first screw 5 exposed between the hook 312 and the crossbar 41, thereby adjusting the height of the screen module 1 fixed to the hanger 3. The position of the hanger 3 relative to the hook 312 in the front and rear direction of the screen module 1 can be adjusted by rotating the second screw 6, thereby the position of the screen module 1 in the front and rear direction of the screen module 1 can be adjusted accordingly, ensuring that the surfaces of each screen module 1 are all in the same plane. The degree of inclination of each screen module 1 in the left and right direction of the screen module 1 can be adjusted by adjusting the positions of the hangers 3 on the back sides of each screen module 1 relative to the hooks 312 through the first screw 5 and the second screw 6. At the same time, the degree of inclination of the screen module 1 in the front and rear direction of the screen module 1 can also be adjusted by adjusting the positions of the hooks 312 on the upper and lower side of each hanger 3 through the second screw 6.

When the hook 312 is hooked on the crossbar 41, the fourth screw 71 can abut against the crossbar 41 from the bottom of the hook 312, and the position of the hook 312 and the crossbar 41 can be fixed by the cooperation of the first screw 5 and the fourth screw 71.

When the third screw 34 is loosened, the sliding connecting member can be slid along the sliding slots 24 of the straight rod 23, and when the sliding connecting member is adjusted to a suitable height position, the third screw 34 is tightened to fix the bracket 4 to the suitable height position.

The splicing of the screen module 1 can be performed in a horizontal or vertical direction without limitation through the above-mentioned splicing manner. As shown in FIG. 1, the 3×2 splicing manner (namely, 3 screen modules 1 in the horizontal direction and 2 screen modules 1 in the vertical direction) is displayed, which is only one of the splicing manners of the screen module 1 on the support structure provided by the present application, when the splicing is completed, a wide screen product can be obtained. Similarly, the screen module 1 can also be spliced into vertical screen products, such as in 2×3 splicing manner (namely, 2 screen modules 1 in the horizontal direction and 3 screen modules 1 in the vertical direction), 3×5 splicing manner (namely, 3 screen modules 1 in the horizontal direction and 5 screen modules 1 in the vertical direction) and other different splicing manners to meet different requirements by using the same support structure. Of course, when the support structure provided by the present application is adopted, the splicing manner of the screen module 1 is not limited to the above manner, and the splicing can be performed according to different usage requirements.

The splicing screen support structure provided by the present application is used for supporting the splicing screen formed by splicing a plurality of screen modules 1, the height and the angle of each screen module can be adjusted by rotating the first screw 5 and the second screw 6 after the screen module 1 is hooked to the crossbar 41 of the bracket 4, thus gaps or skew between the screen modules 1 are avoided, so that the corners of the screen modules 1 can be aligned, thereby improving the flatness and integrity of the entire splicing screen, improving the viewing experience and visual effects.

The structure of the screen module 1 is a preset modular mounting structure. The screen module 1 can be quickly hooked to the crossbar 41 of the bracket 4 through the hanger 3 disposed at the back of the screen module 1, therefore cumbersome preparation work before the LED screen installation is eliminated, thereby the installation speed of the LED screen is greatly improved, quick installation of the LED screen is realized, the labor cost and the installation time are reduced.

The descriptions of the above specification and the embodiments are intended to explain the scope of the application, but do not constitute a limitation to the scope of the application. Other embodiments of the present application and modifications, equivalent substitutions, or other improvements of some of the technical features of the present application obtained by a person skilled in the art, based on common knowledge, common technical knowledge and/or prior art in the art, through logical analysis, reasoning or limited experimentation, by the teaching of present application or the above-mentioned embodiments, should also be considered within the scope of the present application.

What is claimed is:

1. A splicing screen support structure for supporting a splicing screen formed by splicing a plurality of screen modules, comprising:
a base;
a bracket, wherein the bracket is fixed to the base and comprises a horizontally extending crossbar;
a plurality of hangers, wherein each of the plurality of screen modules is provided with at least two hangers of the hangers, and the at least two hangers of the hangers are respectively fixed to two sides of a back of each of the plurality of the screen modules in a one-to-one correspondence;
a plurality of hooks, wherein each of the plurality of hooks is hooked to the horizontally extending crossbar and in a non-rotation connection with each of the plurality of hangers in a one-to-one correspondence;
a plurality of first screws, wherein each of the plurality of first screws is screwed to each of the plurality of hooks in a vertical direction in a one-to-one correspondence and abuts against the horizontally extending crossbar after penetrating each of the plurality of hooks in a one-to-one correspondence; and
a plurality of second screws, wherein each of the plurality of second screws is rotatably connected to each of the plurality of hangers in a one-to-one correspondence while perpendicular to the horizontally extending crossbar in a horizontal direction, and each of the plurality of second screws is also screwed to each of the plurality of hooks in a one-to-one correspondence.

2. The splicing screen support structure according to claim 1, wherein each of the plurality of hangers is provided with a support portion on a side away from a corresponding screen module of the screen modules, and openings are respectively formed on a front end and a rear end of the support portion for supporting each of the plurality of second screws in a one-to-one correspondence.

3. The splicing screen support structure according to claim 2, wherein each of the plurality of hooks is provided with a nut, and each of the plurality of second screws is screwed to the nut in a one-to-one correspondence.

4. The splicing screen support structure according to claim 3, wherein the support portion is further provided with a convex plate, and the convex plate is in a non-rotation cooperation with the nut in a one-to-one correspondence.

5. The splicing screen support structure according to claim 3, wherein the support portion comprises at least two support portions, each of the plurality of hangers is provided with the at least two support portions in the vertical direction, and each of the at least two support portions supports each of the plurality of second screws in a one-to-one correspondence, so that each of the plurality of second screws is rotatably connected to each of the plurality of hangers in a one-to-one correspondence, and each of the plurality of hooks is hooked to the horizontally extending crossbar correspondingly.

6. The splicing screen support structure according to claim 1, wherein the base comprises a seat body and a straight rod, the seat body is provided with a universal wheel, the straight rod is fixed to the seat body, and the bracket is fixed to the straight rod.

7. The splicing screen support structure according to claim 6, further comprising a sliding connecting member and a third screw, wherein the sliding connecting member is fixed to the bracket and fixed to the straight rod by the third screw.

8. The splicing screen support structure according to claim 7, wherein the straight rod is provided with a sliding slot, the sliding connecting member is slidably clamped with the sliding slot, and the third screw screws onto and penetrates the sliding connecting member to abut against a bottom of the sliding slot, so that the sliding connecting member is fixed relative to the sliding slot.

9. The splicing screen support structure according to claim 1, further comprising a plurality of fourth screws, wherein each of the plurality of hooks is provided with a fixing plate on a second side opposite to a first side on which each of the plurality of first screws is screwed to each of the plurality of hooks in a one-to-one correspondence, and each of the plurality of fourth screws is threaded with the fixing plate in the vertical direction in a one-to-one correspondence and penetrates the fixing plate in a one-to-one correspondence to abut the horizontally extending crossbar.
